(19) United States
(12) Patent Application Publication
(10) Pub. No.: US 2026/0330801 A1
(43) Pub. Date: Oct. 22, 2026

(54) METHOD FOR DETERMINING CONTOUR LINE AND IMAGE PROCESSING DEVICE

(71) Applicant: Materials Analysis Technology Inc., HSINCHU COUNTY (TW)

(72) Inventors: Kuan-Chung Lin, Taipei City (TW); Yu-Wei Chang, Hsinchu County (TW); Hui-Ling Yen, Taoyuan City (TW); Hung-Jen Chen, Hsinchu City (TW)

(73) Assignee: Materials Analysis Technology Inc., HSINCHU COUNTY (TW)

(21) Appl. No.: 19/203,143

(22) Filed: May 8, 2025

(30) Foreign Application Priority Data
Apr. 22, 2025 (TW) 114115162

(51) Int. Cl. G06V 10/50; G06T 7/13; G06V 10/24; G06V 10/44

(52) U.S. Cl. CPC G06V 10/50; G06T 7/13; G06V 10/242; G06V 10/44

(57) ABSTRACT

A method for determining a contour line and an image processing device are provided. The method includes: extracting a baseline sub-block including an initial contour point from a target image and determining a plurality of template sub-blocks according to the baseline sub-block; recursively executing a plurality of stages and determining a contour point corresponding to each stage, where an i^{th} stage among the stages comprises: determining a search region in the target image; determining a plurality of candidate sub-blocks in the search region; obtaining a plurality of comparison results between each candidate sub-block and each template sub-block; and selecting a reference sub-block from the candidate sub-blocks according to the comparison results and determining the contour point corresponding to the i^{th} stage according to the reference sub-block; and determining at least a portion of a target contour line based on the contour point corresponding to each stage.

### CROSS-REFERENCE TO RELATED APPLICATION

This application claims the priority benefit of Taiwan application serial no. 114115162, filed on Apr. 22, 2025. The entirety of the above-mentioned patent application is hereby incorporated by reference herein and made a part of this specification.

### BACKGROUND

### Technical Field

The disclosure relates to an image processing technique, and particularly relates to a method for determining a contour line and an image processing device.

### Description of Related Art

In the field of image processing, detection of object contour lines is a technique for identifying object boundaries in images and is mainly used for object segmentation, feature extraction, and shape analysis. Common contour detection methods include edge detection operators (e.g., Sobel, Prewitt, Roberts, and Canny), gradient operations (e.g., Laplacian operator), and active contour models (e.g., Snake and Level Set). Moreover, deep learning techniques (e.g., U-Net and Holistically-Nested Edge Detection, HED) can also achieve high-precision contour line extraction.

However, contour line detection still faces various challenges. For instance, noise in images may lead to false detection or edge blurring. In addition, lighting variations and shadows in images may affect edge intensity, making the detection results of contour lines unstable. Further, complex backgrounds in images may also cause misjudgment of contour lines.

To solve these problems, a person having ordinary skill in the art needs to develop a mechanism for determining contour lines, so as to improve the stability and accuracy of contour detection.

### SUMMARY

Accordingly, the disclosure provides a method for determining a contour line and an image processing device through which the above technical problems are solved.

An embodiment of the disclosure provides a method for determining a contour line implemented by an image processing device. The method includes the following steps. A target image is obtained. The target image includes a target contour line assigned with an initial contour point. A baseline sub-block including the initial contour point is extracted from the target image, and a plurality of template sub-blocks are determined according to the baseline sub-block. A plurality of stages are recursively executed, and a contour point corresponding to each stage is determined. An i^{th} stage among the stages includes the following. A search region is determined in the target image. A plurality of candidate sub-blocks are determined in the search region, where i is an index value. A plurality of comparison results between each candidate sub-block and each template sub-block are obtained. A reference sub-block is selected from the candidate sub-blocks according to the comparison results, and the contour point corresponding to the i^{th} stage is determined according to the reference sub-block. At least a portion of the target contour line is determined based on the contour point corresponding to each stage.

An embodiment of the disclosure further provides an image processing device including a storage circuit and a processor. The storage circuit stores a program code. The processor is coupled to the storage circuit and accesses the program code to obtain a target image, where the target image includes a target contour line assigned with an initial contour point, extract a baseline sub-block including an initial contour point from a target image and determine a plurality of template sub-blocks according to the baseline sub-block, and recursively execute a plurality of stages and determine a contour point corresponding to each stage. A n i^{th} stage among the stages includes the following. A search region is determined in the target image. A plurality of candidate sub-blocks are determined in the search region, where i is an index value. A plurality of comparison results between each candidate sub-block and each template sub-block are obtained. A reference sub-block is selected from the candidate sub-blocks according to the comparison results, and the contour point corresponding to the i^{th} stage is determined according to the reference sub-block. At least a portion of the target contour line is determined based on the contour point corresponding to each stage.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic view illustrating an image processing device according to an embodiment of the disclosure.

FIG. 2 is a flow chart illustrating a method for determining a contour line according to an embodiment of the disclosure.

FIG. 3 is a view illustrating an application scenario according to an embodiment of the disclosure.

FIG. 4 is a flow chart illustrating recursive execution of a plurality of stages according to an embodiment of the disclosure.

FIG. 5 is a view illustrating an application scenario according to an embodiment of the disclosure.

FIG. 6 is a flow chart illustrating determination of a comparison result according to an embodiment of the disclosure.

FIG. 7 is a schematic view of determining the contour line drawn according to FIG. 3 and FIG. 5.

### DESCRIPTION OF THE EMBODIMENTS

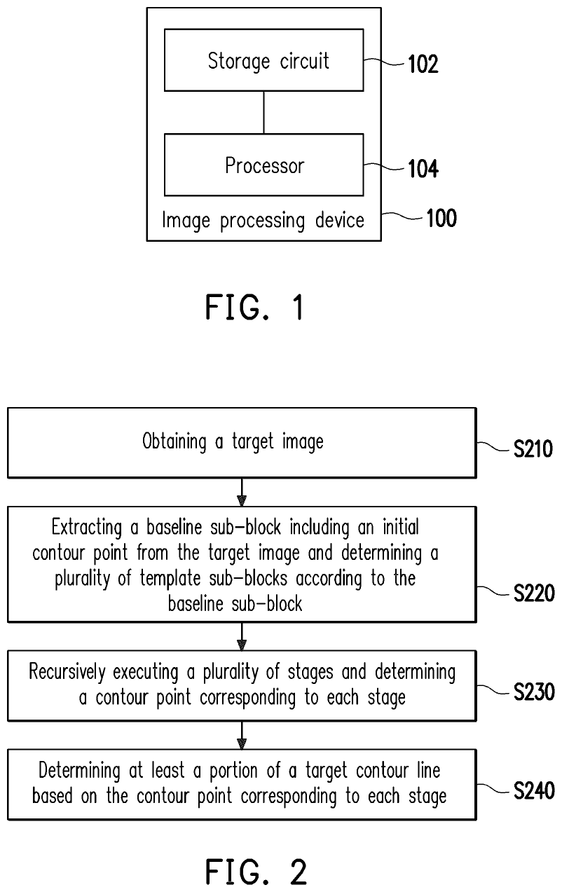

With reference to FIG. 1, which is a schematic view illustrating an image processing device according to an embodiment of the disclosure. In different embodiments, an image processing device 100 may be implemented as various smart devices and/or computer devices, for example, but the disclosure is not limited thereto.

In FIG. 1, the image processing device 100 includes a storage circuit 102 and a processor 104.

The storage circuit 102 is, for example, a fixed or a movable random access memory (RAM) in any form, a read-only memory (ROM), a flash memory, a hard disc, other similar devices, or a combination of the foregoing devices, and may be used to record a plurality of program codes or modules.

The processor 104 is coupled to the storage circuit 102 and is, for example, a processor for general use, a processor for special use, a conventional processor, a digital signal processor, a microprocessor, one or a plurality of microprocessors combined with a digital signal processor core, a controller, a microcontroller, an application specific integrated circuit (ASIC), a field programmable gate array (FPGA) circuit, an integrated circuit of any other types, a state machine, an advanced RISC machine (ARM) based processor, or other similar devices.

In the embodiments of the disclosure, the processor 104 may access modules and program codes recorded in the storage circuit 102 to implement the method of determining a contour line provided in the disclosure, the details are described in the following paragraphs.

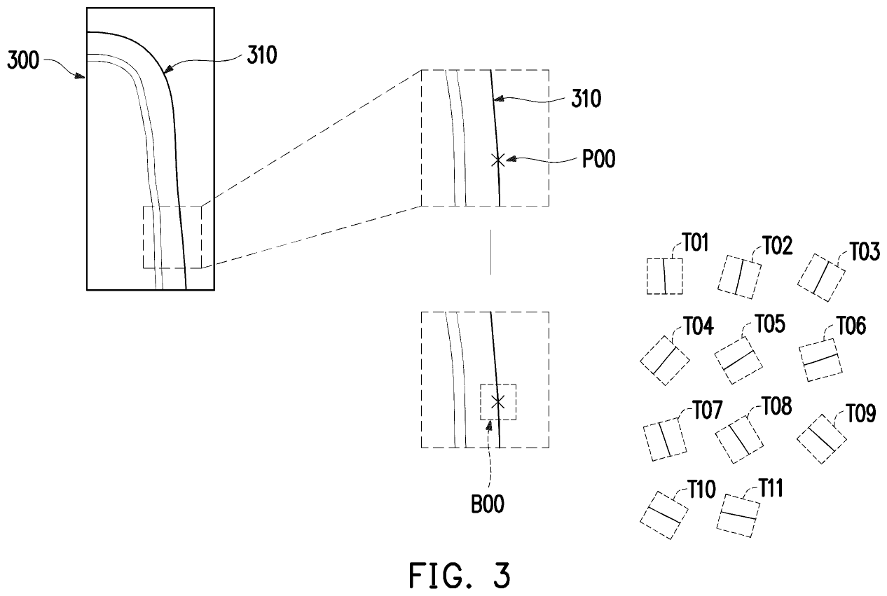

With reference to FIG. 2, which is a flow chart illustrating a method for determining a contour line according to an embodiment of the disclosure. The method provided by this embodiment may be implemented by the image processing device 100 in FIG. 1, and each step in FIG. 2 is described in detail together with the devices shown in FIG. 1. Further, to facilitate understanding of the concepts in the embodiments of the disclosure, the following explanation is supplemented with FIG. 3, where FIG. 3 is a view illustrating an application scenario according to an embodiment of the disclosure.

In step S210, the processor 104 obtains a target image 300. In the embodiments of the disclosure, the target image 300 may refer to an image awaiting contour line recognition, and the processor 104 may obtain unprocessed images from various image sources as the target image 300.

In different embodiments, the target image 300 may come from real-time captures by digital cameras, monitors, or mobile phone cameras, and it may also come from image databases, such as medical images (MRI and X-ray), remote sensing images (satellite photos), or document scan images. In addition, scanner input is also a common source for obtaining images of documents, barcodes, or fingerprints. In some applications, computer-generated synthetic images may also serve as input, such as simulated environments or artificial intelligence generated images, but the disclosure is not limited thereto.

In some embodiments, the target image 300 may also be an image that has undergone various preprocessing (e.g., grayscale conversion, noise reduction, contrast adjustment, etc.), so as to lower the impact of factors such as noise, lighting variations, or blur on the accuracy of subsequent contour detection.

In the scenario of FIG. 3, the target image 300 may be a grayscale image obtained through grayscale conversion. In this case, each pixel in the target image 300 may be a grayscale pixel with a corresponding grayscale value, but the disclosure is not limited thereto.

In the embodiments of the disclosure, the target image 300 includes a target contour line 310, which may be a boundary line between an object of interest (target object) and its background or other objects, but the disclosure is not limited thereto.

In FIG. 3, the target image 300 may be aside partial structure image of a fin field-effect transistor (FinFET), and this FinFET side structure may be the object of interest (i.e., the object awaiting contour line recognition), and a contour line of this target object may be understood as a target contour line 310 under consideration, but the disclosure is not limited thereto.

In an embodiment, the target contour line 310 is assigned with an initial contour point P00.

In an embodiment, the initial contour point P00 may be manually assigned. In this embodiment, the image processing device 100 may, after displaying the target image 300 on a corresponding display device, provide a relevant selection tool for a user to manually select the initial contour point P00 on the target contour line 310. In an embodiment, the user may, after visually confirming the target contour line 310 in the target image 300, manually click to select any point on the target contour line 310 as the initial contour point P00, but the disclosure is not limited thereto.

In step S220, the processor 104 extracts a baseline sub-block B00 including the initial contour point P00 from the target image 300 and determines a plurality of template sub-blocks T01 to T11 according to the baseline sub-block B00.

In an embodiment, the baseline sub-block B00 may be a rectangular block with the initial contour point P00 as a center point and with a preset width and a preset height, but the disclosure is not limited thereto.

In an embodiment, the processor 104 may rotate the baseline sub-block B00 according to a plurality of preset rotation angles to generate the template sub-blocks T01 to T11.

In the scenario of FIG. 3, the preset rotation angles may be 11 angles preset by a designer, and the processor 104 may individually form the template sub-blocks T01 to T11 by rotating the baseline sub-block B00 to these 11 angles.

For instance, the processor 104 may rotate the baseline sub-block B00 by 0 degrees to form the template sub-block T01. As another instance, the processor 104 may rotate the baseline sub-block B00 by 15 degrees to form the template sub-block T02. Additionally, the processor 104 may rotate the baseline sub-block B00 by 30 degrees to form the template sub-block T03.

Based on the above principles, a person having ordinary skill in the art should be able to correspondingly deduce the determination approach for the remaining template sub-blocks T04 to T11, so description thereof is not repeated herein.

In other embodiments, the designer may decide the number and/or angles of the multiple preset rotation angles according to needs, not limited to the pattern shown in FIG. 3.

In step S230, the processor 104 recursively executes a plurality of stages and determines a contour point corresponding to each stage.

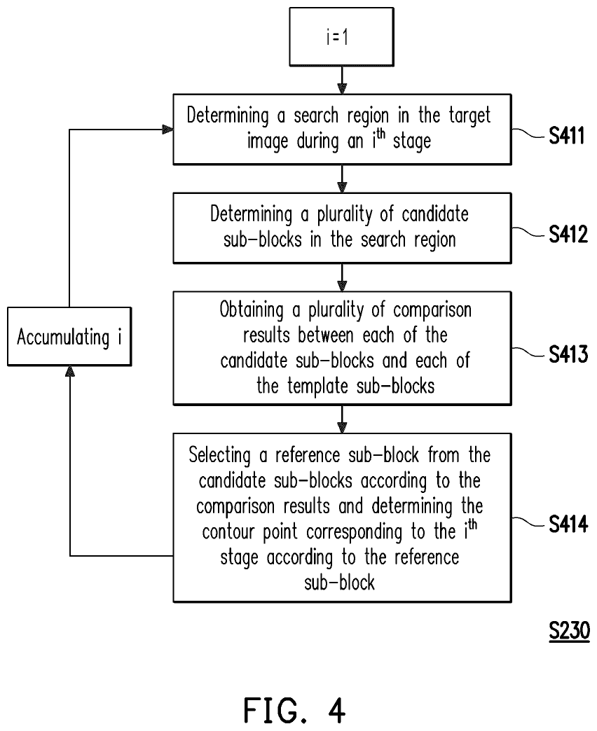

In the embodiments of the disclosure, the processor 104 may implement step S230 by executing the process in FIG. 4.

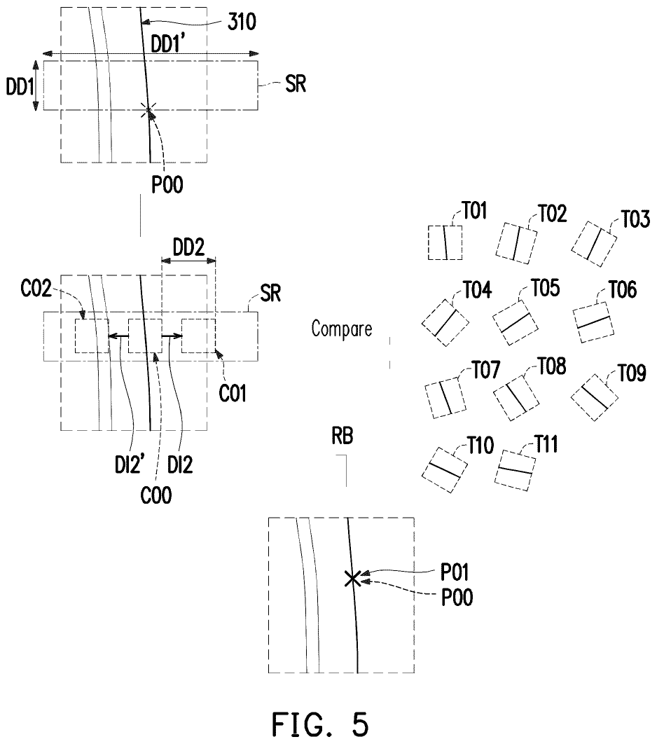

Please refer to FIG. 4, which is a flow chart illustrating recursive execution of a plurality of stages according to an embodiment of the disclosure. Further, to make the concept of FIG. 4 easier to understand, FIG. 5 is used for supplementary explanation in the following paragraphs, where FIG. 5 is a view illustrating an application scenario according to an embodiment of the disclosure.

In the embodiments of the disclosure, the processor 104 may recursively execute one or more steps in FIG. 4 starting from the first stage of the multiple stages, until determining that a specific termination condition is satisfied.

In an embodiment, the processor 104 may determine that the termination condition is satisfied when determining that the process in FIG. 4 has been recursively executed fora specified number of times and subsequently execute step S240, but the disclosure is not limited thereto. In other embodiments, the designer may also set the required termination conditions according to needs, and related instances are to be explained in the following paragraphs.

In step S411, the processor 104 determines a search region SR in the target image 300 during an i^{th} stage.

In the embodiments of the disclosure, i may be used to represent an index value of the recursive count and may be gradually accumulated from an initial value (e.g., 1 as shown in the scenario of FIG. 4), but the disclosure is not limited thereto.

In the scenario of FIG. 5, i is 1, for example. In this case, the processor 104 may determine the search region SR based on the initial contour point P00, where the initial contour point P00 is located on one edge (e.g., a bottom edge) of the search region SR. In this embodiment, the search region SR is a rectangular region with a height DD1 and a width DD1′, for example, and the initial contour point P00 is a middle point of the bottom edge of the search region SR, for example, but the disclosure is not limited thereto.

In other embodiments, the initial contour point P00 may also be located at any position on other edges of the search region SR, and the search region SR may also have other shapes, not limited to the pattern shown in FIG. 5.

In FIG. 5, since the target contour line 310 extends approximately in a vertical direction, the initial contour point P00 may be located on the bottom edge of the search region SR. In other embodiments, since the target contour line 310 extends approximately in the vertical direction, the initial contour point P00 may be located on a top edge of the search region SR, not limited to the implementation approach shown in FIG. 5.

In other embodiments, if the target contour line under consideration extends approximately in a horizontal direction, the initial contour point P00 may also be located on a left/right side edge of the search region SR, but the disclosure is not limited thereto.

In some embodiments, the edge on which the initial contour point P00 is located in the search region SR may be set according to the above principles after the user visually confirms an extension direction of the target contour line 310, but the disclosure is not limited thereto.

In an embodiment, the height DD1 may be set by the user according to needs. For instance, if the user intends to determine each contour point located on the target contour line 310 in a more noise-resistant approach, the user may set the height DD1 and/or width DD1′ to a larger value. On the other hand, if the user intends to determine the target contour line 310 in a more detailed approach, the user may set the height DD1 and/or width DD1′ to a smaller value, but the disclosure is not limited thereto.

Next, in step S412, the processor 104 determines a plurality of candidate sub-blocks C00 to C02 in the search region SR.

In an embodiment, the processor 104 may determine a specific image range in the search region SR and determine a first candidate sub-block based on this image range. In an embodiment, the image range is a rectangular region also having a preset width and preset height, for example. In this case, a size of the image range is the same as the baseline sub-block B00, but the disclosure is not limited thereto.

In FIG. 5, the above-mentioned image range may be located in the middle of the search region SR, for example, but the disclosure is not limited thereto.

After the image range is determined, the processor 104 may treat an image region within this image range in the target image 300 as the first candidate sub-block.

In FIG. 5, candidate sub-block C00 is the first candidate sub-block being considered, for example, but the disclosure is not limited thereto.

After the first candidate sub-block (e.g., candidate sub-block C00) is determined, the processor 104 may move the image range according to a specified direction D12 by a specified distance DD2 and determine a second candidate sub-block among the candidate sub-blocks C00 to C02 based on the image range after movement.

From another perspective, the specified direction D12 may also be understood as perpendicular to the extension direction of the target contour line 310, but the disclosure is not limited thereto.

In an embodiment, the specified distance DD2 may be set by the user according to needs. For instance, if the user intends to more precisely determine each contour point located on the target contour line 310, then the user may set the specified distance DD2 to a smaller value. On the other hand, if the user intends to determine the target contour line 310 with better efficiency, then the user may set the specified distance DD2 to a larger value, but the disclosure is not limited thereto.

In FIG. 5, the processor 104 may move the image range corresponding to candidate sub-block C00 in the specified direction D12 by the specified distance DD2, for example, and then treats the image region within this image range in the target image 300 as the second candidate sub-block (e.g., candidate sub-block C01).

Similarly, the processor 104 may move the image range corresponding to candidate sub-block C00 in another specified direction DI2′ by the specified distance DD2, for example, and then treats the image region within this image range in the target image 300 as a third candidate sub-block (e.g., candidate sub-block C02).

In other embodiments, the processor 104 may also determine more candidate sub-blocks according to the above principle, not limited to the 3 candidate sub-blocks C00 to C02 shown in FIG. 5.

In step S413, the processor 104 obtains a plurality of comparison results between each of the candidate sub-blocks C00 to C02 and each of the template sub-blocks T01 to T11.

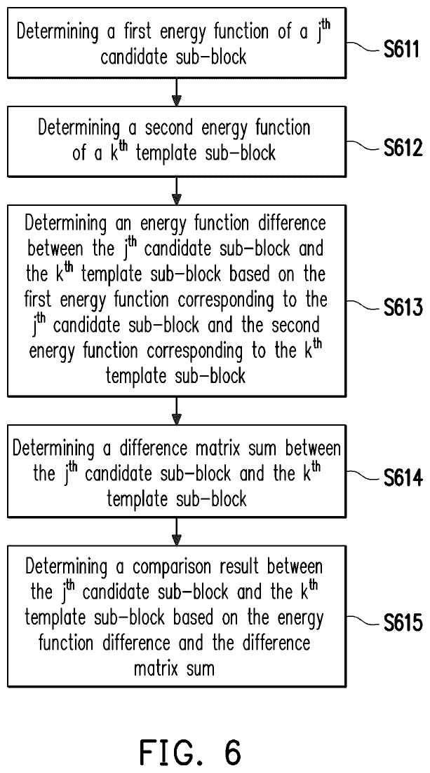

In an embodiment, the processor 104 may determine the comparison result between a j^{th} candidate sub-block (j is an index value) among the candidate sub-blocks C00 to C02 and a k^{th} template sub-block (k is an index value) among the template sub-blocks T01 to T11 according to the process shown in FIG. 6. In the embodiments of the disclosure, 1≤j≤J and 1≤k≤K, where J and K are the number of candidate sub-blocks and the number of template sub-blocks respectively.

For instance, in the scenario of FIG. 3 and FIG. 5, since the number of candidate sub-blocks C00 to C02 is assumed to be 3, 1≤j≤3. Additionally, since the number of template sub-blocks T01 to T11 is assumed to be 11, 1≤k≤11, but the disclosure is not limited thereto.

With reference to FIG. 6, which is a flow chart illustrating determination of a comparison result according to an embodiment of the disclosure.

In step S611, the processor 104 determines a first energy function of the j^{th} candidate sub-block.

In the embodiments of the disclosure, the processor 104 may determine the first energy function of the j^{th} candidate sub-block based on any known mathematical function, and may be used to evaluate the characteristics, structure, or quality of the j^{th} candidate sub-block, but the disclosure is not limited thereto.

In other embodiments, “Snakes: Active contour models” (Kass, M., Witkin, A., & Terzopoulos, D. (1988)), “Active contours without edges” (Chan, T. F., & Vese, L. A. (2001)), “Interactive graph cuts for optimal boundary & region segmentation of objects in N-D images” (Boykov, Y., & Jolly, M. P. (2001)), “Stochastic relaxation, Gibbs distributions, and the Bayesian restoration of images” (Geman, S., & Geman, D. (1984)), and other literature individually record corresponding energy function formulas, and the processor 104 may, for example, determine the first energy function of the j^{th} candidate sub-block using these energy function formulas according to the designer's needs, but the disclosure is not limited thereto.

In an embodiment, the processor 104 may, for example, determine the first energy function of the j^{th} candidate sub-block based on the following formula:

$$E [ L ( y ) ] = {\int }_{{y}_{0}}^{{y}_{1}} [ D ( L ( y ) , y ) + γ S ( {L}^{′} ( y ) ) ] dy + α ( {\int }_{{y}_{0}}^{{y}_{1}} [ α D ( L ( y ) , y ) + βS ( {L}^{′} ( y ) ) ] dy ) .$$

In an embodiment, D(L(y), y) may be expressed by the following formula:

$$D ( L ( y ) , y ) = - \vert I ( L ( y ) - δ , y ) - I ( L ( y ) + δ , y ) \vert + {λ}_{left} {\int }_{0}^{δ} {( I ( L ( y ) - δ , y ) - {I}_{left} )}^{2} d δ + {λ}_{right} {\int }_{0}^{δ} {( I ( L ( y ) - δ , y ) - {I}_{right} )}^{2} d δ .$$

In an embodiment, S(L′(y)) may be expressed by the following formula:

$$S ( {L}^{′} ( y ) ) = {\vert {L}^{′} ( y ) \vert}^{2} .$$

In the embodiments of the disclosure, the physical meanings of the variables in the above formulas may be as shown in the following Table 1.

TABLE 1

| | |
|---|---|
| I(x, y) | 2D pixel array of the target image |
| L(y) | dividing line, x = L(y) |
| δ | specified distance DD2, may be understood as the search |
| | range for the contour point |
| I_{left} | grayscale value on the left side of the dividing line |
| I_{right} | grayscale value on the right side of the dividing line |
| E[L(y)] | energy function of the entire sub-block |
| D(L(y), y) | Recalculate the 2D array of the image, treat the point as the |
| | center, calculate the image difference between left and right |
| | sides based on the & distance, and add a smoothing term for |
| | calculation |
| y₀ | y − lateral range |
| y₁ | y + lateral range; assuming to look for a vertical line, |
| | y₀ and y₁ are the upper and lower boundaries of the sub-block |
| S(L′(y)) | smoothing term |
| λ | parameters controlling the balance between data fidelity and |
| | smoothness |
| r | Upper and lower limit parameters of the dividing line |
| | displacement |

In step S612, the processor 104 determines a second energy function of the k^{th} template sub-block.

In the embodiments of the disclosure, the processor 104 may also determine the second energy function of the k^{th} template sub-block according to the corresponding approach for determining the first energy function of the j^{th} candidate sub-block, the details of which are not repeated herein.

In step S613, the processor 104 determines an energy function difference (hereinafter referred to as D(j, k)) between the j^{th} candidate sub-block and the k^{th} template sub-block based on the first energy function corresponding to the j^{th} candidate sub-block (hereinafter referred to as E1_j) and the second energy function corresponding to the k^{th} template sub-block (hereinafter referred to as E2_k).

In an embodiment, the processor 104 may directly treat the difference between E1_j and E2_k (e.g., E1_j−E2_k, E2_k−E1_j, or |E1_j−E2_k) as D(j, k), but the disclosure is not limited thereto.

In step S614, the processor 104 determines a difference matrix sum (hereinafter referred to as M S(j, k)) between the j^{th} candidate sub-block and the k^{th} template sub-block.

In an embodiment, the processor 104 may determine pixel-by-pixel grayscale differences between the j^{th} candidate sub-block and the k^{th} template sub-block and sum up the pixel-by-pixel grayscale differences between the j^{th} candidate sub-block and the k^{th} template sub-block into the difference matrix sum MS(j, k) between the j^{th} candidate sub-block and the k^{th} template sub-block.

In an embodiment, the difference matrix sum may be characterized as:

$$d ( {L}_{i} ) = ‖ I ( {L}_{i} ) - I ( {L}_{0} ) ‖ = \sqrt{{\sum }_{( x , y ) ∈ P} {[ I ( {L}_{i} , x , y ) - I ( {L}_{0} , x , y ) ]}^{2}} .$$

In step S615, the processor 104 may determine a comparison result between the j^{th} candidate sub-block and the k^{th} template sub-block based on the energy function difference and the difference matrix sum.

In an embodiment, the comparison result between the j^{th} candidate sub-block and the k^{th} template sub-block is a weighted value, for example, and the weighted value may be characterized as:

$$S ( j , k ) = w 1 * D ( j , k ) + w 2 * M S ( j , k ) ,$$

where w1 and w2 are weights (which may be determined by the designer according to needs).

Based on the above, the processor 104 may accordingly determine the comparison result between any one of the candidate sub-blocks C00 to C02 and any one of the template sub-blocks T01 to T11.

Please refer to FIG. 4 again, after step S413, the processor 104 may, in step S414, select a reference sub-block RB from the candidate sub-blocks C00 to C02 according to the comparison results and determine the contour point corresponding to the i^{th} stage according to the reference sub-block RB.

In an embodiment, the reference sub-block RB may be the one corresponding to a lowest weighted value among the candidate sub-blocks C00 to C02. In other embodiments, the processor 104 may also select the reference sub-block RB from the candidate sub-blocks C00 to C02 according to other principles set by the designer (for example, the one corresponding to a second lowest weighted value among the candidate sub-blocks C00 to C02), but the disclosure is not limited thereto.

For ease of understanding, it is assumed in the following paragraphs that the candidate sub-block C00 in FIG. 5 is the reference sub-block RB selected by the processor 104.

In an embodiment, after the reference sub-block RB is determined, the processor 104 may select any point from it as the contour point corresponding to the i^{th} stage (i is currently 1). In an embodiment, the processor 104 may treat, for example, the center point of the reference sub-block RB as a contour point P01 corresponding to the i^{th} stage.

That is, in the scenario of FIG. 5, the processor 104 may treat, for example, the center point of the candidate sub-block C00 as the contour point P01 corresponding to the i^{th} stage.

After that, the processor 104 may accumulate i (the accumulated i may be 2, for example), and return to step S411.

In an embodiment, when i is greater than 1, the processor 104 may determine the search region corresponding to the i^{th} stage based on the contour point corresponding to the (i−1)^{th} stage, where the contour point corresponding to the (i−1)^{th} stage is located on one of the edges of the search region of the i^{th} stage.

For instance, in the 2^{nd} stage, the processor 104 may, during the execution of step S411, determine the search region corresponding to the 2^{nd} stage based on the contour point P01 corresponding to the 1^{st} stage, where the contour point corresponding to the 1^{st} stage is located on one of the edges of the search region of the 2^{nd} stage. Relevant details may refer to the description of step S411 in the foregoing embodiments, and description thereof is thus not repeated herein.

In the first embodiment, after executing step S411, the processor 104 may further determine whether the search region of the i^{th} stage exceeds the image range of the target image 300. Taking the scenario in FIG. 5 as an example, the processor 104 may determine whether the search region SR has exceeded a height of the target image 300. If yes, the processor 104 may determine that the search region SR has exceeded the image range of the target image 300; otherwise, the search region SR has not exceeded the image range of the target image 300, but the disclosure is not limited thereto.

In this embodiment, in response to determining that the search region exceeds the image range of the target image 300, the processor 104 may determine that the termination condition has been satisfied. In this case, the processor 104 may directly execute step S240 of FIG. 2.

On the other hand, in response to determining that the search region does not exceed the image range of the target image 300, the processor 104 may determine that the termination condition has not been satisfied, and may continue to execute step S412 to determine the candidate sub-blocks in the search region.

In the second embodiment, if the processor 104 determines that no candidate sub-block can be found during the execution of step S412, the processor 104 may also determine that the termination condition has been satisfied and accordingly execute step S240 of FIG. 2.

On the other hand, if the processor 104 can still determine one or more candidate sub-blocks during the execution of step S412, the processor 104 may determine that the termination condition has not been satisfied and may continue to execute step S413, but the disclosure is not limited thereto.

In step S240, the processor 104 determines at least a portion of the target contour line 310 based on the contour point corresponding to each stage.

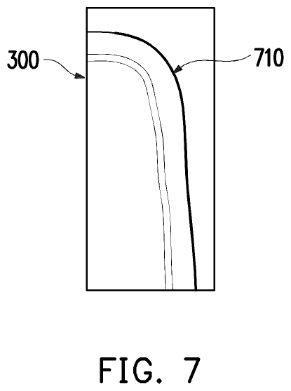

Please refer to FIG. 7, which is a schematic view of determining the contour line drawn according to FIG. 3 and FIG. 5.

In this embodiment, the processor 104 may, after recursively executing multiple stages and determining the contour point corresponding to each stage, connect the contour points of the stages into a portion of a contour line 710 of the target contour line 310.

Alternatively, the processor 104 may also directly present the contour points corresponding to the stages on the target image 300 to form the contour line 710.

In another embodiment, the processor 104 may also determine middle contour points between the contour points of the stages by linear interpolation and then connect all the contour points into a portion of the contour line 710 of the target contour line 310, but the disclosure is not limited thereto.

In view of the foregoing, in the embodiments of the disclosure, a novel, stable, and precise recognition approach is provided for determining at least a portion of the target contour line after obtaining the initial contour point assigned on the target contour line.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A method for determining a contour line implemented by an image processing device, comprising:
obtaining a target image, wherein the target image comprises a target contour line assigned with an initial contour point;
extracting a baseline sub-block comprising the initial contour point from the target image and determining a plurality of template sub-blocks according to the baseline sub-block; and
recursively executing a plurality of stages and determining a contour point corresponding to each stage, wherein an i^{th} stage among the stages comprises:
determining a search region in the target image;
determining a plurality of candidate sub-blocks in the search region, wherein i is an index value;
obtaining a plurality of comparison results between each candidate sub-block and each template sub-block;
selecting a reference sub-block from the candidate sub-blocks according to the comparison results and determining the contour point corresponding to the i^{th} stage according to the reference sub-block; and
determining at least a portion of the target contour line based on the contour point corresponding to each stage.

2. The method according to claim 1, wherein when i is 1, the search region is determined based on the initial contour point located on one edge of the search region.

3. The method according to claim 1, wherein when i is greater than 1, the search region is determined based on a contour point corresponding to an (i−1)^{th} stage, wherein the contour point corresponding to the (i−1)^{th} stage is located on one edge of the search region.

4. The method according to claim 1, wherein the initial contour point is manually assigned.

5. The method according to claim 1, wherein the determining the template sub-blocks according to the baseline sub-block comprises:
rotating the baseline sub-block according to a plurality of preset rotation angles to generate the template sub-blocks.

6. The method according to claim 1, wherein the determining the candidate sub-blocks in the search region comprises:
determining an image range in the search region and determining a first candidate sub-block based on the image range; and
moving the image range according to a specified direction by a specified distance and determining a second candidate sub-block among the candidate sub-blocks based on the image range after movement.

7. The method according to claim 6, wherein the specified direction is perpendicular to an extension direction of the target contour line.

8. The method according to claim 1, wherein the obtaining the comparison results between each candidate sub-block and each template sub-block comprises:
determining a first energy function of a j^{th} candidate sub-block among the candidate sub-blocks, where j is an index value;
determining a second energy function of a k^{th} template sub-block among the template sub-blocks, where k is an index value;
determining an energy function difference between the j^{th} candidate sub-block and the k^{th} template sub-block based on the first energy function corresponding to the j^{th} candidate sub-block and the second energy function corresponding to the k^{th} template sub-block;
determining a difference matrix sum between the j^{th} candidate sub-block and the k^{th} template sub-block; and
determining a comparison result between the j^{th} h candidate sub-block and the k^{th} template sub-block based on the energy function difference and the difference matrix sum.

9. The method according to claim 7, wherein the target image is a grayscale image, and the determining the difference matrix sum between the j^{th} candidate sub-block and the k^{th} template sub-block comprises:
determining pixel-by-pixel grayscale differences between the j^{th} candidate sub-block and the k^{th} template sub-block and summing up the pixel-by-pixel grayscale differences between the j^{th} candidate sub-block and the k^{th} template sub-block into the difference matrix sum between the j^{th} candidate sub-block and the k^{th} template sub-block.

10. The method according to claim 7, wherein the comparison result between the j^{th} candidate sub-block and the k^{th} template sub-block is a weighted value, and the weighted value is characterized as:
$$S ( j , k ) = w 1 * D ( j , k ) + w 2 * M S ( j , k ) ,$$
where D(j, k) is the energy function difference between the j^{th} candidate sub-block and the k^{th} template sub-block, M S(j, k) is the difference matrix sum between the j^{th} candidate sub-block and the k^{th} template sub-block, and w1 and w2 are weights.

11. The method according to claim 1, wherein each of the comparison results is characterized as a corresponding weighted value, and the reference sub-block is the one corresponding to a lowest weighted value among the candidate sub-blocks.

12. The method according to claim 1, wherein the determining the contour point corresponding to the i^{th} stage according to the reference sub-block comprises:
treating a center point of the reference sub-block as the contour point corresponding to the i^{th} stage.

13. The method according to claim 1, wherein the determining at least a portion of the target contour line based on the contour point corresponding to each stage comprises:
integrating the contour points corresponding to the stages into the at least a portion of the target contour line.

14. The method according to claim 1, wherein after determining the search region, the method further comprises:
determining whether the search region exceeds an image range of the target image;
in response to determining that the search region exceeds the image range of the target image, determining to directly determine at least a portion of the target contour line based on the contour point corresponding to each of the stages; and
in response to determining that the search region does not exceed the image range of the target image, determining the candidate sub-blocks in the search region.

15. A n image processing device, comprising:
a non-transitory storage circuit storing a program code; and
a processor coupled to the non-transitory storage circuit and accessing the program code to:
obtain a target image, wherein the target image comprises a target contour line assigned with an initial contour point,
extract a baseline sub-block comprising the initial contour point from the target image and determine a plurality of template sub-blocks according to the baseline sub-block, and
recursively execute a plurality of stages and determine a contour point corresponding to each stage, wherein an i^{th} stage among the stages comprises:
determining a search region in the target image;
determining a plurality of candidate sub-blocks in the search region, wherein i is an index value;
obtaining a plurality of comparison results between each candidate sub-block and each template sub-block; and
selecting a reference sub-block from the candidate sub-blocks according to the comparison results and determining the contour point corresponding to the i^{th} stage according to the reference sub-block; and
determining at least a portion of the target contour line based on the contour point corresponding to each stage.
